(19) United States
(12) Patent Application Publication
(10) Pub. No.: US 2002/0044602 A1
(43) Pub. Date: Apr. 18, 2002

(54) DUAL QUANTIZATION METHOD AND APPARATUS FOR MINIMUM ERROR

(76) Inventor: MITSUHARU OHKI, TOKYO (JP)

Correspondence Address: FROMMER LAWRENCE & HAUG, 745 FIFTH AVENUE- 10TH FL., NEW YORK, NY, 10151, US

(21) Appl. No.: 08/935,927

(22) Filed: Sep. 23, 1997

(30) Foreign Application Priority Data
Sep. 26, 1996 (JP) 8-254273

(51) Int. Cl. H04N 7/12

(52) U.S. Cl. 375/240.03

(57) ABSTRACT

In a quantizing method, a quantizing apparatus, and a coding method, and also a coding apparatus, an error between data dequantized by a decoder and a DCT coefficient of an encoder can be minimized. A DCT circuit compresses an image signal to produce a DCT coefficient corresponding to this image signal, and outputs this DCT coefficient to a quantizing unit. A quantizing circuit of this quantizing unit converts the DCT coefficient into intermediate data by utilizing a first quantizing scale, and calculates an average value of the intermediate data in a predetermined range from an occurrence probability distribution of the intermediate data. Further, the quantizing circuit 11 calculates a second quantizing scale from this average value and the first quantizing scale. This quantizing circuit 11 converts the DCT coefficient into another intermediate data by using the second quantizing scale. A representative value circuit 12 converts the intermediate data within a predetermined range into such a value that a value dequantized by the second quantizing scale becomes the above-described average value, and also outputs both the second quantizing scale and such a value that the dequantized value becomes a reference value to a variable length coding device.

### BACKGROUND OF THE INVENTION

1. Field of the Invention

The present invention generally relates to a quantizing method, a quantizing apparatus, and a decoding method, and also a decoding apparatus. More specifically, the present invention is directed to such quantizing method/apparatus and such decoding method/apparatus, capable of reducing errors caused by quantization.

2. Description of the Related Art

Currently, MPEG (Moving Picture coding Experts Group) systems (e.g., MPEG 1 and MPEG 2) are defined by the International Organization for Standardization (ISO).

In encoders with using MPEG 1 and MPEG 2, after image data is compressed by the discrete cosine transform (DCT), the compressed image data is quantized. Then, the quantized data is coded by the variable length manner to produce variable length code which will then be outputted from the encoder.

Then, a decoder corresponding to this encoder, firstly decodes the code coded by the MPEG system by the variable length coding, and thereafter dequantizes the decoded data to produce the dequantized data. The decoder performs the inverse discrete cosine transform (IDCT) with respect to the produced dequantized data to thereby obtain the original image data.

Subsequently, process operations of these encoder and decoder will now be explained in detail.

First, in the encoder, image data of 1 frame is subdivided into a plurality of micro blocks which are constituted by NY pieces of luminance signal blocks of 8×8 pixels, and also NC pieces of color difference signal blocks of 8×8 pixels (namely, (NY+NC) pieces of (8×8) pixels-blocks in total).

Furthermore, this macro block is subdivided into NY pieces of luminance signal blocks constructed of 8×8 pixels, and NC pieces of color difference signal blocks constructed of 8×8 pixels, namely (NY+NC) pieces of blocks made of 8×8 pixels in total.

Next, each of these blocks is converted into 8×8 pieces of frequency data by way of the discrete cosine transform. These 64 pieces of frequency data are referred to as “DCT coefficients”, and numbers from 0 to 63 are allocated to the DCT coefficients in the line scanning order. In other words, the DCT coefficient located in a u-th (u=1, - - - , 7) row and a v-th (v=1, - - - , 7) column corresponds to an (8×u+v)-th DCT coefficient.

Then, this DCT coefficient is quantized. First, i-th quantized data is calculated from the i-th DCT coefficient by utilizing a weighting coefficient W[i] corresponding to an i-th (i=0, - - - , 63) DCT coefficient and a quantizing scale Q which is used to control an output amount of a variable length code at a post stage.

That is, such a value (namely, DCT coefficient/(W[i]×Q/16)) obtained by dividing the DCT coefficient by a value produced by dividing a product of W[i] and Q by 16 will constitute quantized data. The DCT coefficient is an integer, whereas quantized data becomes a real number.

It should be noted that the quantizing scale “Q” is calculated in correspondence with the present code amount by way of a predetermined control circuit. When the code amount is large, the quantizing scale Q is set to the large value. When the code amount is small, the quantizing scale Q is set to the small value. Thus, the produced code amount is controlled to the proper amount in this manner, and the variable length code is outputted from the encoder at a predetermined transfer rate. Also, since the quantizing scale Q is not every the micro block (namely, quantizing scale Q is not set every block of 8×8 pixels), the value of the quantizing scale Q is constant while one micro block is processed.

Next, the quantized data corresponding to the real number is converted into representative value data corresponding to the value of this quantized data. Then, Signed Level (will be discussed later) corresponding to this representative value data is variable-length-coded in combination with the quantizing scale Q and the like, and the variable-length-coded data is outputted from the encoder.

It should be noted that generally speaking, the expression “quantizing” contains all of expressions used in this specification, namely “quantizing”, “being converted into representative value data”, and “output of Signed Level corresponding thereto”. However, since these process operations are especially related to the present invention, these process operations are subdivided into the above-described three items, for the sake of easy understandings. The following explanations are made based on these subdivided process operations.

A decoder for decoding the variable length code produced in the above-described manner first decodes the variable length code outputted from the above-described encoder and the like, and thereafter dequantizes the decoded variable length code.

In other words, the decoder once converts the decoded Signed Level into the representative value data, and multiplies this representative value data by the above-described W[i]×Q/16 to thereby produce the dequantized data. Then, the decoder converts this dequantized data by the inverse discrete cosine manner to thereby produce the original data. In this dequantizing process operation, the weighting coefficient W[i] (namely, identical to weighting coefficient W[i] owned by encoder) previously stored in this decoder is utilized, and also the quantizing scale contained in the code supplied to the decoder. That is, the decoder extracts the quantizing scale set by the encoder from the supplied code and then utilizes this extracted code in the dequantizing operation.

Next, a description will now be made of process operation for converting the quantized data into the representative value data. This converting process operation is performed in the following different manners. That is, the converting process operation is carried out with respect to an intra-macro block (coded in frame), whereas the converting process operation is carried out with respect to a non-intra-macro block (coded between frames). The following descriptions will now be made of the two different cases, i.e., intra-macro block, and non-intra-macro block.

In the case that the quantized data for the intra-macro block is converted into the representative value data, as indicated in FIG. 1, i-th quantized data belonging to a range from (t−0.5) to (t+0.5) defined with respect to an integer “t” is converted into representative value data whose value is equal to “t”. It should be noted that since a DCT coefficient corresponding to a zeroth DCT coefficient in the intra-macro block is quantized in a different sequential operation from that of other DCT coefficients (namely, first to 63rd DCT coefficients), only the first DCT coefficient through the 63rd DCT coefficient will be handled in the following process operations.

In the case that the quantized data for the non-intra-macro block is converted into the representative value data, as indicated in FIG. 2, i-th quantized data belonging to a range from −1 to +1 is converted into representative value data whose value is equal to 0, and also i-th quantized data belonging to another range from (tt−0.5) to (tt+0.5) is converted into representative value data whose value “tt”. The last-mentioned range is defined with respect to a value added by 0.5 for a positive integer “t” (otherwise, a value subtracted from 0.5 for a negative integer “t”).

It should be understood that the above-explained integer “t” is called as “Signed Level” in the MPEG 1 and the MPEG 2. In the variable length coding process, this Signed Level is coded.

As a consequence, as shown in FIG. 3, in the case of the intra-macro block, the DCT coefficient existing in the range from (t−0.5)×W[i]×Q/16 to (t+0.5)×W[i]×Q/16 is converted into the representative value data whose value is equal to “t”, and Signed Level whose value is equal to “t” and which corresponds to this representative value data is coded in the encoder. Then, this Signed Level is converted into the dequantized data whose value is equal to t×W[i]×Q/16 in the decoder.

For instance, in such a case that the value of the DCT coefficient is equal to 0.6×W[i]×Q/16 (symbol “g” in FIG. 3), the value of the quantized data becomes 0.6 (symbol F(g) in FIG. 3), and both the representative value data and the value of Signed Level become 1. Then, this Signed Level is supplied to the decoder, and the value thereof is converted into the dequantized data equal to 1×W[i]×Q/16. A squared error I(eg)² between the DCT coefficient and the dequantized data at this time becomes (0.4×W[i]×Q/16)² (={(1.0−0.6)×W[i]×Q/16]²}.

Also, for instance, in such a case that the value of the DCT coefficient is equal to 2.2×W[i]×Q/16 (symbol “h” in FIG. 3), the value of the quantized data becomes 2.2 (symbol F(h) in FIG. 3), and both the representative value data and the value of Signed Level become 2. Then, this Signed Level is supplied to the decoder, and the value thereof is converted into the dequantized data equal to 2×W[i]×Q/16. A squared error I(eh)² between the DCT coefficient and the dequantized data at this time becomes (0.2×W[i]×Q/16)² (={(2.0−2.2)×W[i]×Q/16}²).

On the other hand, as indicated in FIG. 4, in the case of the non-intra-macro block, the DCT coefficient existing in the range from −1.0×W[i]×Q/16 to 1.0×W[i]×Q/16 is converted into the representative value data whose value is equal to 0 in the encoder. In the decoder, this representative value data is converted into the dequantized data whose value is equal to 0×W[i]×Q/16 (=0).

Then, the DCT coefficient having the value existing in the range from (tt−0.5)×W[i]×Q/16 to (tt+0.5)×W[i]×Q/16 is converted into the representative value whose value is equal to “tt”, and Signed Level whose value is equal to “t” (in case of tt>0, t=tt−0.5, tt<0, t=tt+0.5) and which corresponds to this representative value data is coded in the encoder. Then, in the decoder, after this Signed Level is converted into the representative value data “tt”, this representative value data is converted into the dequantized data whose value is equal to tt×W[i]×Q/16.

For example, when the value of the DCT coefficient is equal to 1.1×W[i]×Q/16 (symbol “j” in FIG. 3), the value of the quantized data becomes 1.1 (symbol F(j) in FIG. 3), and the value of the representative value data becomes 1.5 (value of Signed Level becomes 1). Then, this Signed Level is supplied to the decoder, and such a value obtained by adding only 0.5 to Signed Level is converted into the dequantized data whose value is equal to 1.5×W[i]×Q/16. A squared error I(ej)² between the DCT coefficient and the dequantized data at this time becomes (0.4×W[i]×Q/16)² (={(1.5−1.1)×W[i]×Q/16}²).

For example, when the value of the DCT coefficient is equal to 2.7×W[i]×Q/16 (symbol “k” in FIG. 3), the value of the quantized data becomes 2.7 (symbol F(k) in FIG. 3), and the value of the representative value data becomes 2.5 (value of Signed Level becomes 2). Then, this Signed Level is supplied to the decoder, and such a value obtained by adding only 0.5 to Signed Level is converted into the dequantized data whose value is equal to 2.5×W[i]×Q/16. A squared error I(ek)² between the DCT coefficient and the dequantized data at this time becomes (0.2×W[i]×Q/16)² (={(2.5−2.7)×W[i]×Q/16}²).

However, in the process operation with respect to the intra-macro block, as indicated in FIG. 5, for example, the occurrence probability distribution of the quantized data (namely, occurrence probability distribution of input data) is not constant in the range defined from 0.5 to 1.5 (namely, higher occurrence probability in case of quantized data whose value is approximated to 0). As a consequence, when the quantized data existing in the range from 0.5 to 1.5 is converted into the representative value data whose value is equal to 1, the squared mean error between the quantized data existing in the range from 0.5 to 1.5, and the representative value data may not be minimized.

Similarly, in the process operation with respect to the non-intra-macro block, because the occurrence probability distribution of the quantized data (namely, occurrence probability distribution of input data) is not constant, the squared mean error between the quantized data and the representative value data may not be minimized in a preselected range.

As a consequence, in the above-described methods, there is such a problem that since the squared mean error between the quantized data and the representative value data becomes large (namely, error between DCT coefficient in encoder and dequantized data in decoder becomes large), the S/N ratio of the original image data converted by the decoder would be deteriorated.

### SUMMARY OF THE INVENTION

The present invention has been made to solve the above-explained object, and therefore, has an object to provide a quantizing method, a quantizing apparatus, and a coding method, and also a coding apparatus, capable of reducing an error between data dequantized in a decoder and a DCT coefficient of an encoder.

To achieve the above-described object, according to an aspect of the present invention, a quantizing apparatus for quantizing input data in correspondence with a predetermined quantizing scale is comprised of: a first calculating unit for calculating a reference value from an occurrence probability distribution of intermediate data in a predetermined range, which is obtained by converting the input data by using a first quantizing scale, the reference value corresponding to the predetermined range; a second calculating unit for calculating a second quantizing scale from the reference value and the first quantizing scale; a first converting unit for converting the input data into the intermediate data by utilizing the second quantizing scale; a second converting unit for converting the intermediate data in the predetermined range into such a value that a value dequantized by the second quantizing scale becomes the reference value; and an output unit for outputting both such a value that the value dequantized by the second quantizing scale becomes the reference value, and the second quantizing scale.

Also, according to another aspect of the present invention, a quantizing method for quantizing input data in correspondence with a predetermined quantizing scale is comprised of: a step for calculating a reference value from an occurrence probability distribution of intermediate data in a predetermined range, which is obtained by converting the input data by using a first quantizing scale, the reference value corresponding to the predetermined range; a step for calculating a second quantizing scale from the reference value and the first quantizing scale; a step for converting the input data into the intermediate data by utilizing the second quantizing scale; a step for converting the intermediate data in the predetermined range into such a value that a value dequantized by the second quantizing scale becomes the reference value; and a step for outputting both such a value that the value dequantized by the second quantizing scale becomes the reference value, and the second quantizing scale.

According to another aspect of the present invention, a coding apparatus for coding an image signal is comprised of: a data converting unit for frequency-converting the image signal and for outputting image conversion data corresponding to the image signal; a quantizing unit for quantizing the image conversion data by a predetermined quantizing scale; a coding unit for coding the quantized image conversion data; and a calculating unit for calculating the quantizing scale in correspondence with an amount of a code outputted from the coding unit; wherein the quantizing unit is further comprised of: a first calculating unit for calculating a reference value from an occurrence probability distribution of intermediate data in a predetermined range, which is obtained by converting the input data by using a first quantizing scale, the reference value corresponding to the predetermined range; a second calculating unit for calculating a second quantizing scale from the reference value and the first quantizing scale; a first converting unit for converting the input data into the intermediate data by utilizing the second quantizing scale; a second converting unit for converting the intermediate data in the predetermined range into such a value that a value dequantized by the second quantizing scale becomes the reference value; and an output unit for outputting both such a value that the value dequantized by the second quantizing scale becomes the reference value, and the second quantizing scale.

Further, according to another aspect of the present invention, a coding method for coding an image signal, is comprised of: a step for frequency-converting the image signal and for outputting image conversion data corresponding to the image signal; a step for quantizing the image conversion data by a predetermined quantizing scale; a step for coding the quantized image conversion data; and a step for calculating the quantizing scale in correspondence with an amount of a code outputted from the coding unit; wherein the quantizing step is further comprised of: a step for calculating a reference value from an occurrence probability distribution of intermediate data in a predetermined range, which is obtained by converting the input data by using a first quantizing scale, the reference value corresponding to the predetermined range; a step for calculating a second quantizing scale from the reference value and the first quantizing scale; a step for converting the input data into the intermediate data by utilizing the second quantizing scale; a step for converting the intermediate data in the predetermined range into such a value that a value dequantized by the second quantizing scale becomes the reference value; and a step for outputting both such a value that the value dequantized by the second quantizing scale becomes the reference value, and the second quantizing scale.

Also, according to a further aspect of the present invention, in a machine-readable-program storage medium for storing a program instruction executable by the machine so as to execute a process step for quantizing image data, the process step is comprised of: a step for calculating a reference value from an occurrence probability distribution of intermediate data in a predetermined range, which is obtained by converting the input data by using a first quantizing scale, the reference value corresponding to the predetermined range; a step for calculating a second quantizing scale from the reference value and the first quantizing scale; a step for converting the input data into the intermediate data by utilizing the second quantizing scale; a step for converting the intermediate data in the predetermined range into such a value that a value dequantized by the second quantizing scale becomes the reference value; and a step for outputting both such a value that the value dequantized by the second quantizing scale becomes the reference value, and the second quantizing scale.

Moreover, according to another aspect of the present invention, in a machine-readable-program storage medium for storing a program instruction executable by the machine so as to execute a process step for quantizing image data, the process step is comprised of: a step for frequency-converting the image signal and for outputting image conversion data corresponding to the image signal; a step for quantizing the image conversion data by a predetermined quantizing scale; a step for coding the quantized image conversion data; and a step for calculating the quantizing scale in correspondence with an amount of a code outputted from the coding unit; wherein the quantizing step is further comprised of: a step for calculating a reference value from an occurrence probability distribution of intermediate data in a predetermined range, which is obtained by converting the input data by using a first quantizing scale, the reference value corresponding to the predetermined range; a step for calculating a second quantizing scale from the reference value and the first quantizing scale; a step for converting the input data into the intermediate data by utilizing the second quantizing scale; a step for converting the intermediate data in the predetermined range into such a value that a value dequantized by the second quantizing scale becomes the reference value; and a step for outputting both such a value that the value dequantized by the second quantizing scale becomes the reference value, and the second quantizing scale.

### BRIEF DESCRIPTION OF THE DRAWINGS

For a better understanding of the present invention, reference is made of a details description to be read in conjunction with the accompanying drawings, in which:

FIG. 1 illustrates an example of the relationship among the DCT coefficient, the representative value data, and Signed Level in the conventional quantizing process operation with respect to the intra-macro block;

FIG. 2 illustrates an example of the relationship among the DCT coefficient, the representative value data, and Signed Level in the conventional quantizing process operation with respect to the non-intra-macro block;

FIG. 3 represents an example of the relationship among the DCT coefficient, the quantized data, the representative value data, and the dequantized data in the data coding and data decoding process operations with respect to the intra-macro block;

FIG. 4 represents an example of the relationship among the DCT coefficient, the quantized data, the representative value data, and the dequantized data in the data coding and data decoding process operations with respect to the non-intra-macro block;

FIG. 5 graphically shows an example of the occurrence probability distribution of the quantized data in the case of the intra-macro block;

FIG. 6 is a schematic block diagram for representing an arrangement of a coding apparatus according to an embodiment of the present invention;

FIG. 7 is a flow chart for explaining operations of the coding apparatus of FIG. 6;

FIG. 8 graphically shows an example of an occurrence probability distribution of quantized data in case of the intra-macro block;

FIG. 9 graphically indicates an example of a range for values of quantized data used to calculate an average value “α” in case of the intra-macro block;

FIG. 10 illustrates an example of a relationship among a value of a DCT coefficient, a value of quantized data, representative value data, and Signed Level in case of the intra-macro block;

FIG. 11 graphically shows an example of an occurrence probability distribution of quantized data in case of the non-intra-macro block;

FIG. 12 graphically indicates an example of a range for values of quantized data used to calculate an average value “γ” in case of the non-intra-macro block;

FIG. 13 graphically shows an example of a range for values of quantized data used to actually calculate an average value “ε” in case of the non-intra-macro block;

FIG. 14 illustrates an example of a relationship among a value of a DCT coefficient, a value of quantized data, representative value data, and Signed Level in case of the non-intra-macro block; and

FIG. 15 is a schematic block diagram for indicating an arrangement of a coding apparatus according to another embodiment of the present invention.

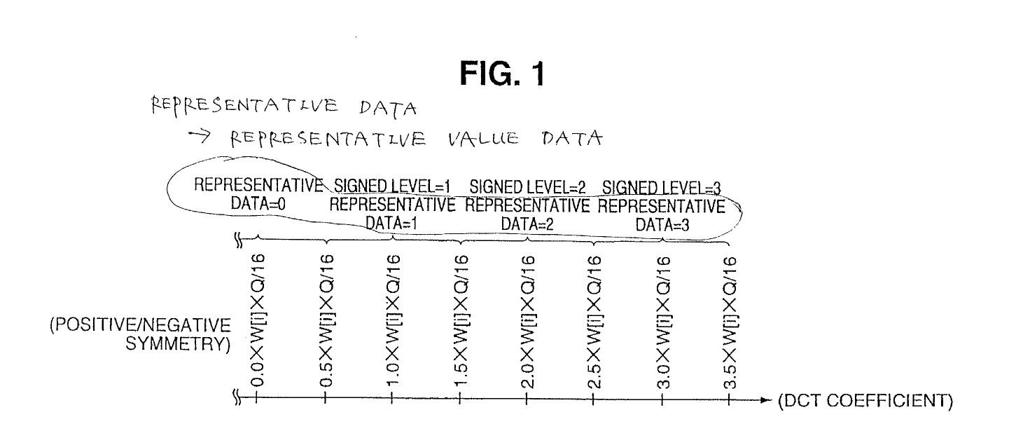

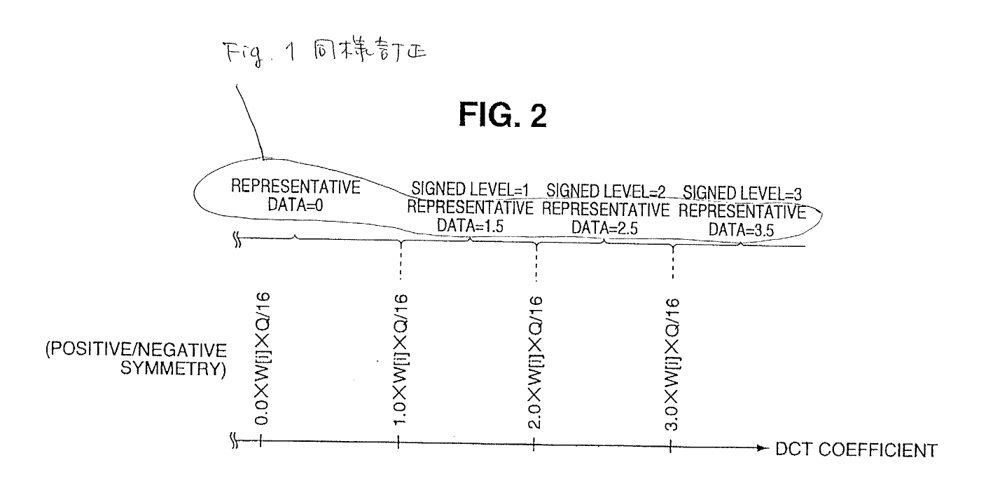

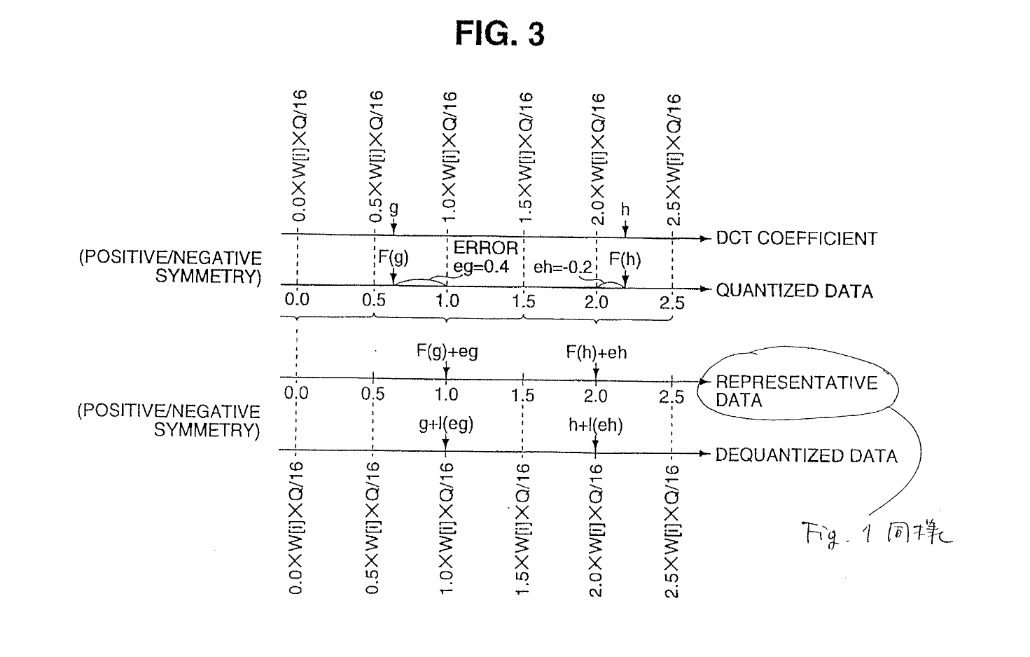

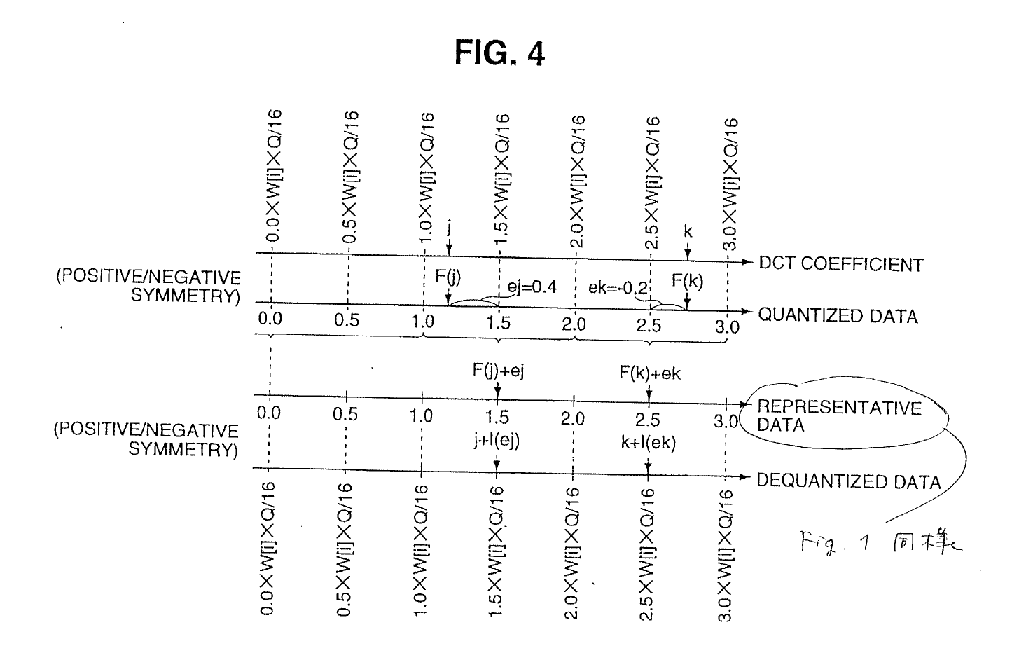

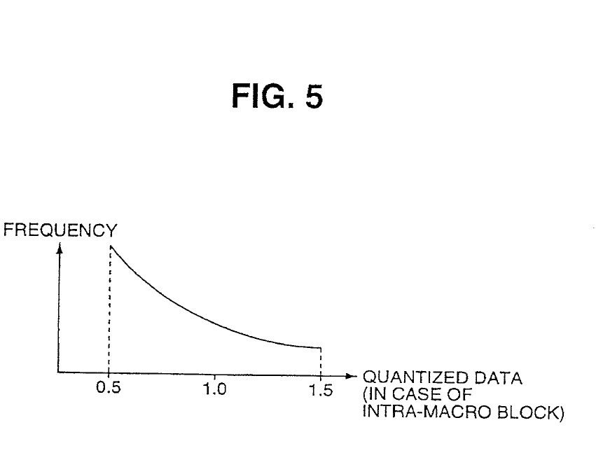

### DETAILED DESCRIPTION OF THE PREFERRED EMBODIMENTS

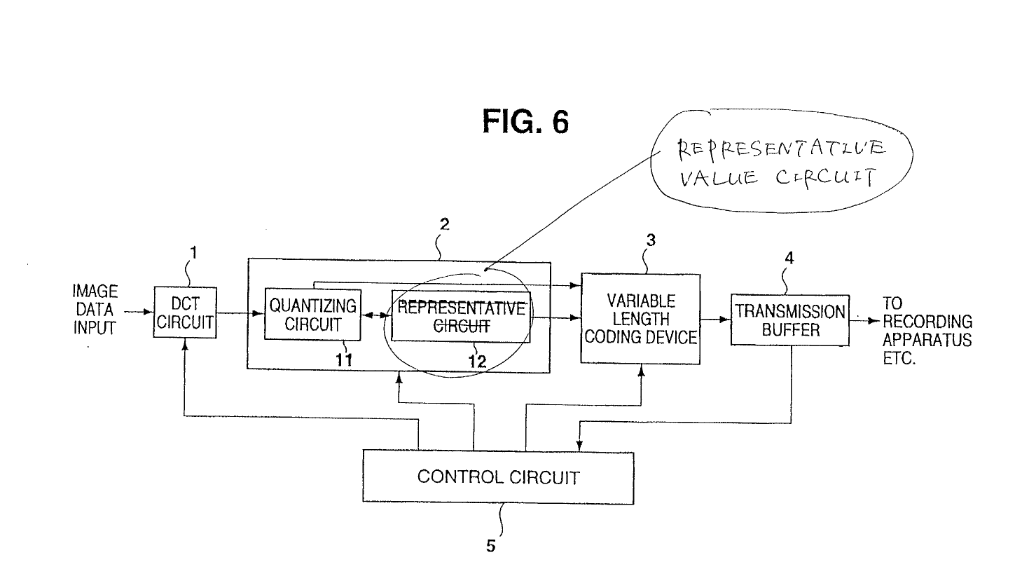

FIG. 6 represents an arrangement of a coding apparatus according to an embodiment mode of the present invention. A DCT circuit 1 converts inputted image data by way of the discrete cosine transform, and outputs a DCT coefficient produced by the discrete cosine transform to a quantizing circuit 11 of a quantizing unit 2.

In the quantizing circuit 11 of the quantizing unit 2, the DCT coefficient is divided by such a value obtained by dividing a product by 16, and then outputs this calculation result as quantized data (intermediate data) to a representative value circuit 12. This product is made of a weighting coefficient W[i] corresponding to each of the DCT coefficients stored in a built-in table, and either a quantizing scale Q (first quantizing scale) supplied from the control circuit 5 or another quantizing scale New Q (second quantizing scale) (will be discussed later).

In such a case that a micro block under process is an intra-macro block, the quantizing circuit 11 calculates an average value “α” (reference value) of quantized data whose values are present within a range from 0.5 to 1.5 from a distribution of values of quantized data (namely, data calculated in correspondence with quantizing scale Q) within 1 macro block. Furthermore, the quantizing circuit 11 calculates a product (α×Q) between this average value a and the quantizing scale Q supplied from the control circuit 5, and selects such a value from the 31 values of the preset quantizing scales, which is most close to this product, and then outputs this value as a quantizing scale New Q used in the decoder to the representative value circuit 12 and a variable length coding device 3.

Furthermore, in the case that the macro block under process is a non-intra-macro block, the quantizing circuit 11 calculates an average value “ε” (reference value) of the quantized data whose values are present in a range from 1.0 to 7/3 from the distribution of the value of the quantizing data in 1 macro block. Also, the quantizing circuit 11 calculates a product (ε×⅔×Q) between a value obtained by multiplying this average value by ⅔, and the quantizing scale Q supplied from the control circuit 5. Then, the quantizing circuit 11 selects such a value from the 31 values of the preset quantizing scales, which is most close to this product, and then outputs this value as a quantizing scale New Q used in the decoder to the representative value circuit 12 and the variable length coding device 3.

The representative value circuit 12 of the quantizing unit 2 converts the quantized data into representative value data by utilizing the quantizing scale New Q supplied from the quantizing circuit 11 and the quantizing scale Q supplied from the control circuit 5.

The variable length coding device 3 variable-length-codes the Signed Level, the quantizing scale New Q, and the like, which correspond to the representative value data supplied from the quantizing unit 2, and then outputs the produced variable length code to a transmission buffer 4.

The transmission buffer 4 temporarily stores therein these supplied variable length codes, and sequentially outputs the variable length codes in a predetermined transfer rate.

A control circuit 5 controls the respective circuits, and also monitors an amount of the codes stored in the transmission buffer 4. Then, the control circuit 5 calculates a quantizing scale Q corresponding to this code amount to output the calculated quantizing scale Q to the quantizing unit 2, so that the production amount of the variable codes is controlled.

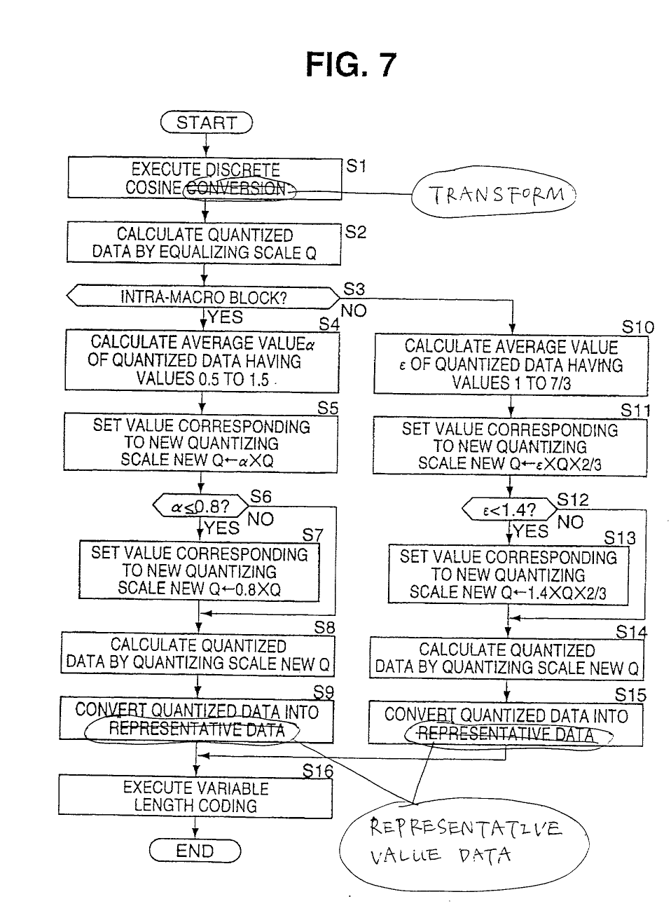

Referring now to a flow chart shown in FIG. 7, operations of the coding apparatus shown in FIG. 6 will be described.

At a first step S1 of this flow chart, the DCT circuit 1 discrete-cosine-converts the entered image data with respect to each block constituted by, for example, 8×8 pixels to obtain the DCT coefficient, and then outputs the DCT coefficient to the quantizing circuit 11 of the quantizing unit 2.

Next, at a step S2, the quantizing circuit 11 of the quantizing unit 2 produces one macro block amount of the quantized data from one macro block amount of the DCT coefficient by utilizing the weighting coefficient W[i] corresponding to each of the DCT coefficients stored in the built-in table, and also the quantizing scale Q supplied from the control circuit 5.

For example, in such a case that a macro block constructed of 6 pieces (=NY+NC in total) of blocks made of 8×8 pixels is processed and 384 (=6×8×6) pieces of DCT coefficients are supplied, when this macro block is equal to the intra-macro block, the quantizing circuit 11 divides 378 pieces of these DCT coefficients except for the DC components (zeroth DCT coefficients) of the respective blocks by such a value obtained by dividing the product between the weighting coefficient W[i] (i=1, - - - , 63) and the quantizing scale Q by 16 respectively, and thus produces 378 pieces of quantized data. The above-described 6 pieces of macro blocks are constituted by 4 pieces (NY=4) of luminance signal blocks made of 8×8 pixels, and also 2 pieces (NC=2) of color difference signal blocks made of 8×8 pixels.

Similarly, when this macro block is equal to the non-intra-macro block, the quantizing circuit 11 divides 384 pieces of DCT coefficients by such a value obtained by dividing the product between the weighting coefficient W[i] (i=1, - - - , 63) and the quantizing scale Q by 16 respectively, and then produces 384 pieces of quantized data. As an example, since 6 pieces of blocks are present in the macro block, there are 6 sets of the i-th DCT coefficients.

At a step S3, the quantizing circuit 11 judges as to whether or not the macro block under process is equal to the intra-macro block. When the quantizing circuit 11 judges that the macro block under process is equal to the intra-macro block, the process operation is advanced to a step S4.

At the step S4, the quantizing circuit 11 calculates the average value “α” of the quantized data whose values are present in the range from 0.5 to 1.5 from the distribution of the values for 1 macro block amount of quantized data. Further, at a step S5, the quantizing circuit 11 calculates the product between this average value and the quantizing scale Q supplied from the control circuit 5, and selects such a value most close to this product from the 31 values of the preset quantizing scales, and then sets this value as the quantizing scale New Q utilized on the side of the decoder.

Then, at a step S6, the quantizing circuit 11 judges as to whether or not the average value “α” is smaller than, or equal to 0.8. When it is so judged that the average value “α” is smaller than, or equal to 0.8, the average value “α” is set to 0.8 in order that the difference between the quantizing scale Q set by the control circuit 5 in correspondence with the code amount of the transmission buffer 4 and the quantizing scale New Q does not become so large. Furthermore, the quantizing circuit 11 selects the value of the quantizing scale most close to 0.8×Q from 31 pieces of the preset quantizing scale values, and sets this value as the quantizing scale New Q used on the decoder side. In other words, in this case, New Q is again set.

On the other hand, at a step S6, when it is so judged that the average value “α” is greater than, or equal to 0.8, the process operation skips over a step S7.

It should be noted that the above-described average value “α” may be calculated as follows:

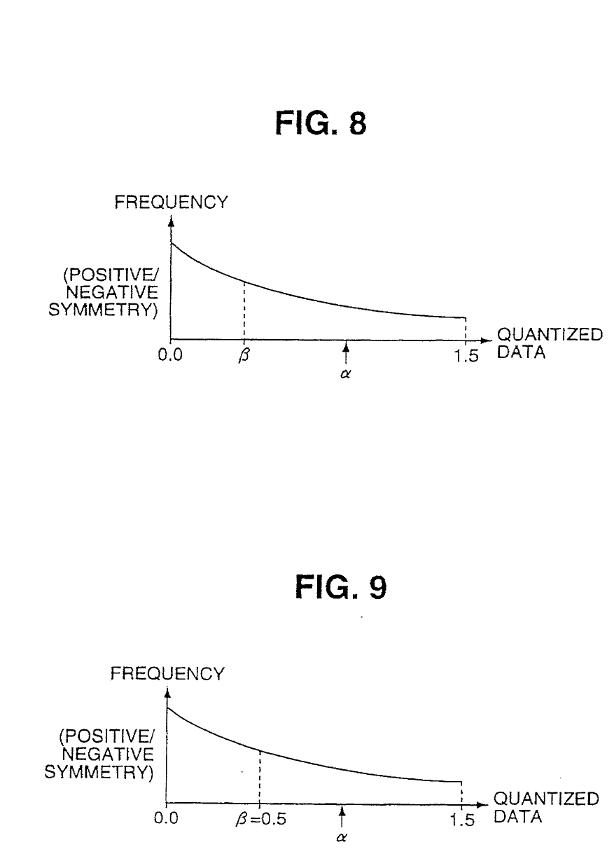

In the case of the intra-macro block, as indicated in FIG. 8, the values of the quantized data in 1 micro block are concentrated near 0, and the most values of quantized data are present in a range from −0.5 to 1.5.

At this time, in order to reduce the difference between the quantized data and the representative value data, the quantized data whose value is present in a range from 0 to β among the quantized data whose values are present within a range from 0 to 1.5 is preferably converted into the representative value data whose value is equal to 0. Also, the quantized data whose value is present in a range from β to 1.5 is preferably converted into the representative value data whose value is equal to an average value “α” of this range. Similarly, the quantized data whose value is present in a range from 0 to −β among the quantized data whose values are present within a range from 0 to −1.5 is preferably converted into the representative value data whose value is equal to 0. Also, the quantized data whose value is present in a range from −β to −1.5 is preferably converted into the representative value data whose value is equal to “−α”.

However, since the representative value data in the case of the intra-macro block is limited to the integer, while a predetermined integer is outputted as the representative value data on the encoder side, the value of the quantizing scale supplied to the decoder side is calculated in correspondence with this average value. On the decoder side, the value of the dequantized data produced in response to this quantizing scale may be equal to this average value.

Next, both this β and the average value α of the quantized data within the range from β to 1.5 are selected in such a manner that a squared mean error between either 0 or a and the quantized data in the range from 0 to 1.5 can be minimized. This squared mean error E² is expressed by the following formula. It should be noted in this formula that only such quantized data whose value is positive is handled for the sake of easy explanation.

$${E}^{2} = {\sum }_{i = 1}^{63} \{ {\int }_{0}^{β} {( \frac{W [ i ] Q}{16} ( 0 - x ) )}^{2} Pi ( x ) ⅆ x + {\int }_{β}^{1.5} {( \frac{W [ i ] Q}{16} ( α - x ) )}^{2} Pi ( x ) ⅆ x \}$$

In this formula, symbol “x” indicates the value of the quantized data, and symbol Pi(x) denotes probability at which the value of the i−th quantized data is equal to “x”.

As shown in FIG. 9, since such a prediction is made that a is nearly equal to 1 and also β is nearly equal to 0.5, while β is fixed to 0.5, a calculation is made of a value of a under such a condition that the squared mean error E² can be minimized. At this time, the squared mean error E² may be expressed by the following formula. It should also be noted that the reason why β is made equal to 0.5 is to achieve a simple calculation.

$${E}^{2} = {\sum }_{i = 1}^{63} \{ {\int }_{0}^{0.5} {( \frac{W [ i ] Q}{16} ( 0 - x ) )}^{2} Pi ( x ) ⅆ x + {\int }_{0.5}^{1.5} {( \frac{W [ i ] Q}{16} ( α - x ) )}^{2} Pi ( x ) ⅆ x \}$$

Then, such an a that this squared mean error E² can be minimized is expressed by the following formula:

$$α = \frac{{\sum }_{i = 1}^{63} \{ {( \frac{W [ i ] Q}{16} )}^{2} {\int }_{0.5}^{1.5} \times Pi ( x ) ⅆ x \}}{{\sum }_{i = 1}^{63} \{ {( \frac{W [ i ] Q}{16} )}^{2} {\int }_{0.5}^{1.5} Pi ( x ) ⅆ x \}}$$

The quantizing circuit 11 modifies the integration of the above-described formula into a summation, and calculates an average value “α” thereof in accordance with the following formula in the case that the quantized data whose value is negative is involved:

$$α = \frac{{\sum }_{i = 1}^{63} {\sum }_{} \{ \vert {x}_{ji} \vert {( \frac{W [ i ] Q}{16} )}^{2} \}}{{\sum }_{i = 1}^{63} {\sum }_{} \{ {( \frac{W [ i ] Q}{16} )}^{2} \}}$$

$$j ∈ \{ k \vert 0.5 ≦ \vert {x}_{ki} \vert ≦ 1.5 , 1 ≦ k < N \}$$

In this formula, symbol “xⱼᵢ” indicates a value of i−th quantized data of a j-th (j=1, - - - , N) block, and further symbol “N” denotes a total number (NY+NC) of blocks for constituting a macro block.

It should also be noted a set of {k|0.5≦|xₖᵢ|≦1.5, 1≦k<N} indicates such a set of numbers of blocks which contain such an i−th quantized data whose absolute value is located in a range from 0.5 to 1.5 among the i−th quantized data of the respective blocks in the macro block.

The quantizing circuit 11 calculates the average value α in the above-described manner.

At the next step S8, the quantizing circuit 11 recalculates the quantized data by utilizing the quantizing scale New Q.

At a step S9, the representative value circuit 12 of the quantizing unit 2 converts the quantized data into representative value data by using a constant “λ” calculated by the below-mentioned formula based upon the quantizing scale New Q supplied from the quantizing circuit 11 and the quantizing scale Q supplied from the control circuit 5:

λ={1.5×W[i]×Q/16−1.5×W[i]×New Q/16}/2.

In the case of the intra-micro block, within such a range that the value of the quantized data calculated in correspondence with the quantizing scale Q is larger than, or equal to −1.5 as well as is smaller than, or equal to 1.5, occurrence probability of the value of this quantized data is greatly varied in response to the value of the quantized data. As a consequence, as described above, the quantizing circuit 11 sets a new quantizing scale New Q (quantizing scale used on side of decoder) in such a manner that the average value of the quantized data within this range. is made in correspondence with the value of the dequantized data on the side of the decoder.

On the other hand, in such a case that the absolute value of the quantized data is sufficiently large, occurrence probability of the value of the quantized data is substantially constant. As a consequence, with respect to each of the ranges defined by the new quantizing scales New Q, the quantized data contained in this range is converted into such representative value data having a center value of this range, so that a squared mean error between the DCT coefficient on the encoder side and the data dequantized by using the quantizing scale New Q on the decoder side must be reduced.

In other words, in the case of the intra-macro block, when the value “g” of the quantized data calculated in correspondence with the quantizing scale New Q is present in a range from (y−0.5) to (y+0.5) corresponding to such an integer “y” whose absolute value is sufficiently large, the value “g” of this quantized data is converted into representative value data whose value is equal to “y”.

Accordingly, the representative value circuit 12 sets the range of the quantized data corresponding to the representative value data in such a manner that this range is gradually transferred to the range defined by the new quantizing scale New Q within such a range that the value of the quantized data calculated in correspondence with the quantizing scale Q is larger than, or equal to −1.5 and is smaller than, or equal to 1.5, and within such a region that the absolute value of the quantizing data is sufficiently large.

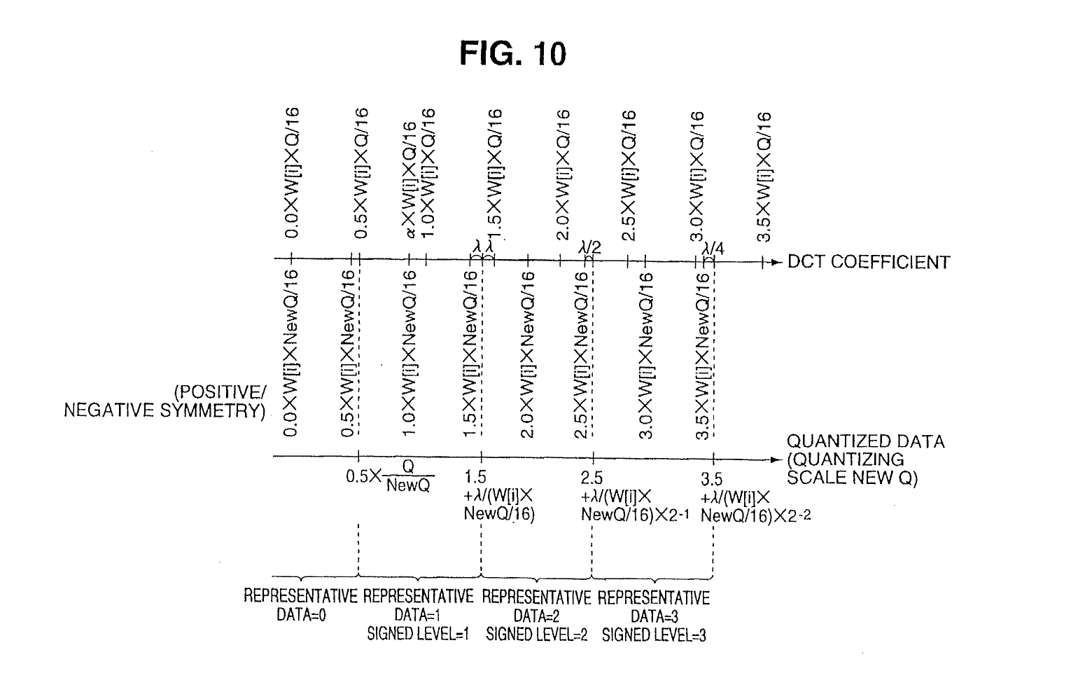

That is to say, as indicated in FIG. 10, in the case of the intra-macro block, when the value of the quantized data (namely, calculated in correspondence with quantizing scale New Q) is present in a range defined from −0.5×Q/New Q to 0.5×Q/New Q (namely, range corresponding to range from −0.5 to 0.5 when quantizing scale is equal to Q), the representative value circuit 12 sets the value of the representative value data to 0. In the case that the value of the quantized data is located in a range defined from 0.5×Q/New Q to 1.5+λ/(W[i]×New Q/16), the representative value circuit 12 sets the value of the representative value data to 1. Also, in the case that the value of the quantized data is located in a range defined from (j−0.5)+λ/(W[i]×New Q/16)×2^{-(j-2)} to (j+0.5)+λ/(W[i]×New Q/16)×2^{-(J-1)}, the representative value circuit 12 sets the value of the representative value data to j. That is, the value of the DCT coefficient is located in a range (j≧2) defined from (j −0.5)×W[i]×New Q/16)+λ×2^{-(j-2)} to (j+0.5)×W[i]×New Q/16)+λ×2^{-(j-1)}.

Similarly, in the case of the intra-macro block, when the value of the quantized data is located in a range defined from −0.5×Q/New Q to −1.5−λ/(W[i]×New Q/16), the representative value circuit 12 sets the value of the representative value data to −1. Also, when the value of the quantized data is located in a range (j≧2) defined from −(j −0.5)×λ/(W[i]×New Q/16)×2^{-(j-2)} to −(j+0.5)−λ/(W[i]×New Q/16)×2^{-(j-1)}, the representative value circuit 12 sets the value of the representative value data to −j.

Therefore, the squared mean error between the quantized data and the representative value data can be reduced in the entire range by performing the above-explained manner.

On the other hand, at the step S3, when the quantizing circuit 11 judges that the macro block under process operation is not equal to the intra-macro block (namely, macro block under process operation is equal to the non-intra-macro block), the process operation is advanced to a step S10.

At this step S10, the quantizing circuit 11 calculates an average value “ε” of quantized data whose values are present in a range from 1.0 to 7/3 from a distribution of quantized data in 1 macro block. Furthermore, at a step S11, the quantizing circuit 11 calculates a product (ε×⅔×Q) between a value obtained by multiplying this average value ×⅔ and the quantizing scale Q supplied from the control circuit 5, and selects such a value of a quantizing scale, which is most close to this product, from the 31 values of the preset quantizing scales, and then sets this selected value as a quantizing scale New Q used in the decoder.

Then, at a step S12, the quantizing circuit 11 judges as to whether or not the average value “ε” is smaller than, or equal to 1.4. When the quantizing circuit 11 judges that the average value “ε” is smaller than, or equal to 1.4, this quantizing circuit 11 sets the average value “ε” to 1.4 in order that the difference between the quantizing scale set by the control circuit 5 in correspondence with the code amount of the transmission buffer 4 and the quantizing scale New Q does not become so large. Furthermore, the quantizing circuit 11 selects such a value of a quantizing scale, which is most close to 1.4×⅔×Q, from the 31 values of the preset quantizing scales, and then sets this selected value as a quantizing scale New Q used on the decoder side. That is to say, in this case, the quantizing scale New Q is again set.

On the other hand, when it is so judged at the step S12 that the average value “ε” is larger than 1.4, the process operation defined at the step S13 is skipped.

The above-described average value “ε” is calculated as follows:

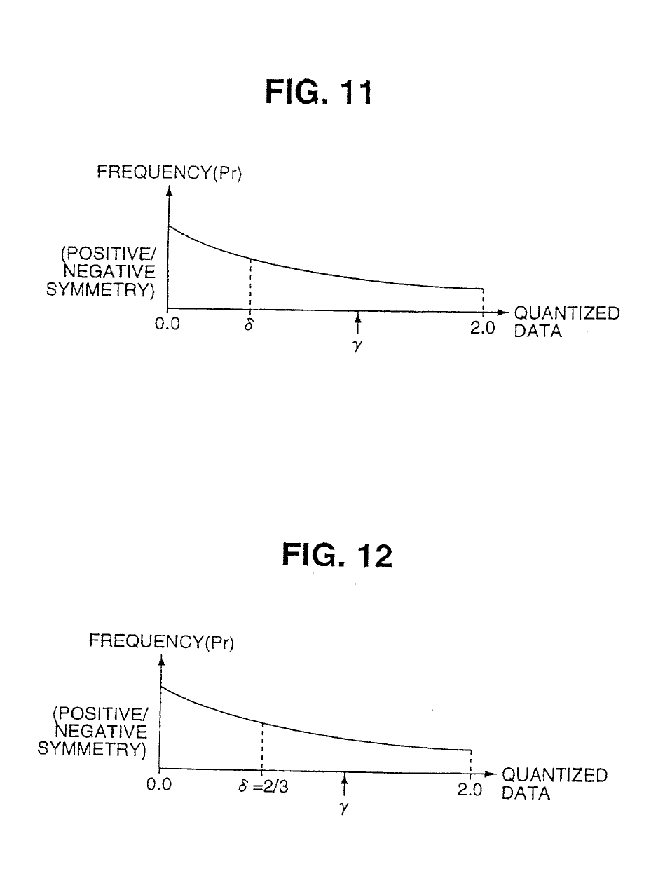

In the case of the non-intra-macro block, as indicated in FIG. 11, the values of the quantized data in 1 micro block are concentrated near 0, and the most values of quantized data are present in a range from −2.0 to 2.0.

At this time, in order to reduce the difference between the quantized data and the representative value data, the quantized data whose value is present in a range from 0 to 8 among the quantized data whose values are present within a range from 0 to 2.0 is preferably converted into the representative value data whose value is equal to 0. Also, the quantized data whose value is present in a range from δ to 2.0 is preferably converted into the representative value data whose value is equal to an average value “γ” of this range. Similarly, the quantized data whose value is present in a range from 0 to “−δ” among the quantized data whose values are present within a range from 0 to −2.0 is preferably converted into the representative value data whose value is equal to 0. Also, the quantized data whose value is present in a range from “−δ” to −2.0 is preferably converted into the representative value data whose value is equal to “−γ”.

However, since the representative value data in the case of the non-intra-macro block is limited to a value (integer+0.5), while a value (preselected integer+0.5) corresponding to a predetermined integer is outputted as the representative value data on the encoder side, the value of the quantizing scale supplied to the decoder side is calculated in correspondence with this average value. On the decoder side, the value of the dequantized data produced in response to this quantizing scale may be equal to this average value.

Next, both this δ and the average value γ of the quantized data within the range from δ to 2.0 are selected in such a manner that a squared mean error between either 0 or γ and the quantized data in the range from 0 to 2.0 can be minimized. This squared mean error E² is expressed by the following formula. It should be noted in this formula that only such quantized data whose value is positive is handled for the sake of easy explanation.

$${E}^{2} = {\sum }_{i = 0}^{63} \{ {\int }_{0}^{δ} {( \frac{W [ i ] Q}{16} ( 0 - x ) )}^{2} Pi ( x ) ⅆ x + {\int }_{δ}^{2.0} {( \frac{W [ i ] Q}{16} ( γ - x ) )}^{2} Pi ( x ) ⅆ x \}$$

In this formula, symbol “x” indicates the value of the quantized data, and symbol Pi(x) denotes probability at which the value of the i-th quantized data is equal to “x”.

As shown in FIG. 12, since such a prediction is made that γ is nearly equal to 4/3 and also δ is nearly equal to ⅔, δ may be fixed to ⅔. When δ is set to ⅔, only such quantized data whose value is from 0 to ⅔ is converted into representative value data whose value is equal to 0. While the quantized data whose value is present in the range from 0 to 1 is converted into the representative value data whose value is equal to 0 as the initial condition, the control circuit 5 predicts the amount of the code produced by the variable length coding device 3, and then calculates the quantizing scale Q. When the number of such representative value data whose values are equal to 0 is greatly different, there are possibilities that the amount of codes which is greatly different from the predicted amount of codes is produced by the variable length coding device 3.

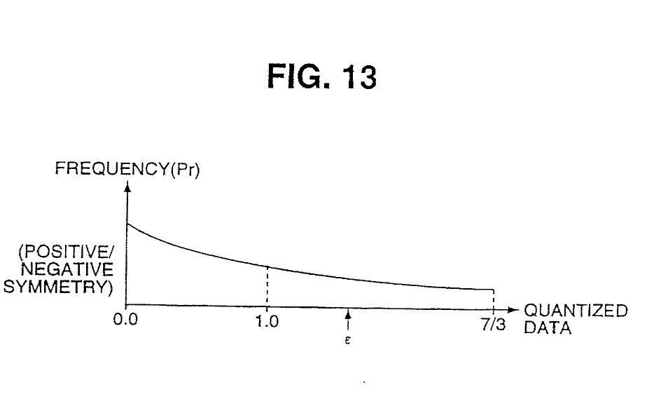

As a consequence, as represented in FIG. 13, the range used to calculate the average value is shifted only by ⅓ to be defined from 1 to 7/3. Then, in this range, a calculation is made of such a value “ε” (namely, average value) capable of minimizing a squared mean error E². At this time, this squared mean error E² is expressed by the following formula:

$${E}^{2} = {\sum }_{i = 1}^{63} \{ {\int }_{0}^{1.0} {( \frac{W [ i ] Q}{16} ( 0 - x ) )}^{2} Pi ( x ) ⅆ x + {\int }_{1.0}^{7 / 3} {( \frac{W [ i ] Q}{16} ( ϵ - x ) )}^{2} Pi ( x ) ⅆ x \}$$

Then, “ε” capable of minimizing this squared mean error E² is calculated by the following formula:

$$ϵ = \frac{{\sum }_{i = 0}^{63} \{ {( \frac{W [ i ] Q}{16} )}^{2} {\int }_{1.0}^{7 / 3} \times Pi ( x ) ⅆ x \}}{{\sum }_{i = 0}^{63} \{ {( \frac{W [ i ] Q}{16} )}^{2} {\int }_{1.0}^{7 / 3} Pi ( x ) ⅆ x \}}$$

The quantizing circuit 11 modifies the integration of the above-described formula into a summation, and calculates an average value “ε” thereof in accordance with the following formula in the case that the quantized data whose value is negative is involved:

$$ϵ = \frac{{\sum }_{i = 1}^{63} {\sum }_{} \{ \vert {x}_{ji} \vert {( \frac{W [ i ] Q}{16} )}^{2} \}}{{\sum }_{i = 1}^{63} {\sum }_{} \{ {( \frac{W [ i ] Q}{16} )}^{2} \}}$$

$$j ∈ \{ k \vert 1.0 ≦ \vert {x}_{ki} \vert ≦ 7 / 3 , 1 ≦ k < N \}$$

In this formula, symbol “xⱼᵢ” indicates a value of i-th quantized data of a j-th (j−1, - - - , N) block, and further symbol “N” denotes a total number (NY+NC) of blocks for constituting a macro block.

It should also be noted a set of {k|1.0≦|xₖᵢ|≦7/3, 1≦k<N} indicates such a set of numbers of blocks which contain such an i-th quantized data whose absolute value is located in a range from 1.0 to 7/3 among the i-th quantized data of the respective blocks in the macro block.

At the next step S14, the quantizing circuit 11 recalculates the quantized data by utilizing the quantizing scale New Q.

At a step S15, the representative value circuit 12 of the quantizing unit 2 converts the quantized data into representative value data by using a constant “π” calculated by the below-mentioned formula based upon the quantizing scale New Q supplied from the quantizing circuit 11 and the quantizing scale Q supplied from the control circuit 5:

π={7/3×W[i]×Q/16−2.0×W[i]×New Q/16}/2.

In the case of the non-intra-micro block, within such a range that the value of the quantized data calculated in correspondence with the quantizing scale Q is larger than, or equal to −2.0 as well as is smaller than, or equal to 2.0, occurrence probability of the value of this quantized data is greatly varied in response to the value of the quantized data. As a consequence, as described above, the quantizing circuit 11 sets a new quantizing scale New Q (quantizing scale used on side of decoder) in such a manner that the average value of the quantized data within this range is made in correspondence with the value of the dequantized data on the side of the decoder.

On the other hand, in such a case that the absolute value of the quantized data is sufficiently large, occurrence probability of the value of the quantized data is substantially constant. As a consequence, with respect to each of the ranges defined by the new quantizing scales New Q, the quantized data contained in this range is converted into such representative value data having a center value of this range, so that a squared mean error between the DCT coefficient on the encoder side and the data dequantized by using the quantizing scale New Q on the decoder side must be reduced.

In other words, in the case of the non-intra-macro block, when the value “g” of the quantized data calculated in correspondence with the quantizing scale New Q is present in a range from y to (y+1) corresponding to such an integer “y” whose absolute value is sufficiently large, the value “g” of this quantized data is converted into representative value data whose value is equal to “y+0.5”.

Accordingly, the representative value circuit 12 sets the range of the quantized data corresponding to the representative value data in such a manner that this range is gradually transferred to the range defined by the new quantizing scale New Q within such a range that the value of the quantized data calculated in correspondence with the quantizing scale Q is larger than, or equal to −2.0 and is smaller than, or equal to 2.0, and within such a region that the absolute value of the quantizing data is sufficiently large.

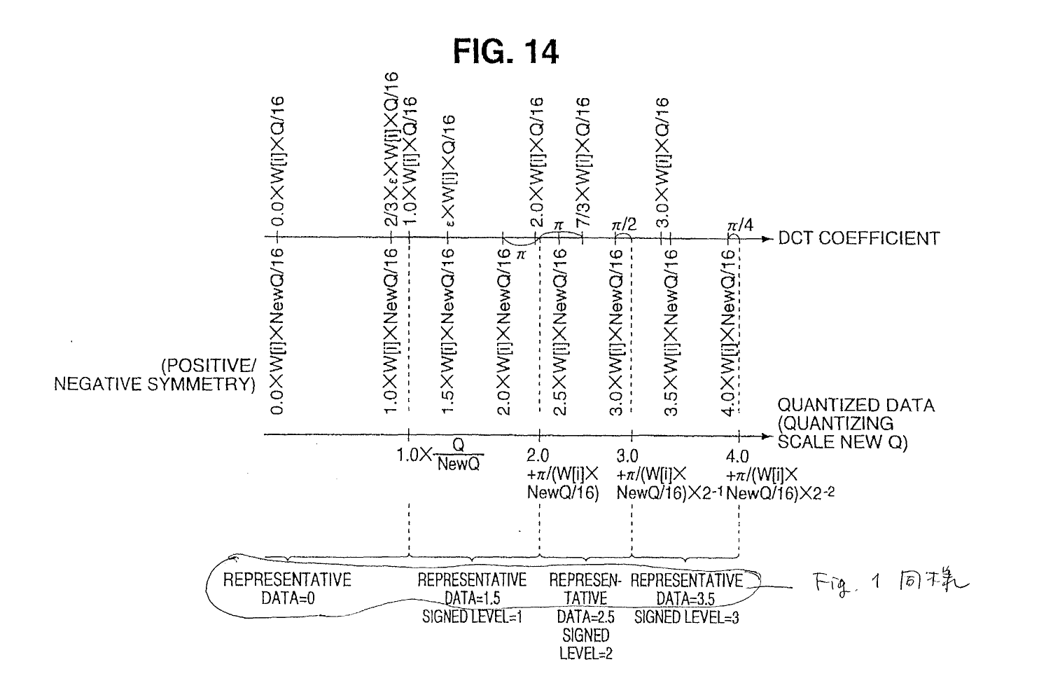

That is to say, as indicated in FIG. 14, in the case of the non-intra-macro block, when the value of the quantized data is present in a range defined from −1.0×Q/New Q to 1.0×Q×New Q (namely, range corresponding to range from −1.0 to 1.0 when quantizing scale is equal to Q), the representative value circuit 12 sets the value of the representative value data to 0. In the case that the value of the quantized data is located in a range defined from 1.0×Q/New Q to 2.0+π/(W[i]×New Q/16), the representative value circuit 12 sets the value of the representative value data to 1.5. Also, in such a case that the value of the quantized data is present in a range (j≧2) defined from j +π/(W[i]×New Q/16)×2^{-(j-2)} to (j+1)+π/(W[i]×New Q/16)×2^{-(j-1)} (namely, value of DCT coefficient is located in range from j×W[i]×New Q/16+π×2^{-(j-2)} to (j+1)×W[i]×New Q/16+π×2^{-(j-1)}, the value of the representative value data is set to (j+0.5).

Similarly, in the case of the non-intra-macro block, when the value of the quantized data is located in a range defined from −1.0×Q/New Q to −2.0−n/(W[i]×New Q/16), the representative value circuit 12 sets the value of the representative value data to −1.5. Also, when the value of the quantized data is located in a range (j≧2) defined from −j−π/(W[i]×New Q/16)×2^{-(j-2)} to −(j+1)−π/(W[i]×New Q/16)×2^{-(j-1)}, the value of the representative value data is set to −(j+0.5).

Therefore, the squared mean error between the quantized data and the representative value data can be reduced in the entire range by performing the above-explained manner.

After the representative value data has been calculated from the quantized data in the above-described manner, the process operation is advanced to a step S16.

At the step S16, the variable length decoding device 3 variable-length-decodes Signed Level, the quantizing scale New Q, and the like, which correspond to the representative value data supplied from the quantizing unit 2, and then outputs the produced code to the transmission buffer 4. Then, the transmission buffer 4 temporarily stores therein the supplied code, and outputs this stored code in a predetermined transfer rate. At this time, the control circuit 5 monitors the amount of the codes stored in the transmission buffer 4, and calculates a quantizing scale Q corresponding to this monitored amount to thereby output the calculated quantizing scale to the quantizing unit 2.

Since the quantizing scale New Q is supplied as the code to the decoder, for instance, when the intra-macro block is entered, if Signed Level is equal to 1, then the dequantized data becomes 1×W[i]×New Q/16 (=α×W[i]×Q/16), and also the DCT coefficient is decoded as the average value of the above-explained range. Accordingly, the squared mean error between the DCT coefficient and the dequantized data can be reduced.

As previously described, in the coding apparatus shown in FIG. 6, after Signed Level corresponding to the selected representative value data by considering the occurrence probability distribution of the quantized data is coded, the coded Signed Level is outputted together with the new quantizing scale New Q by the quantizing unit 2. It should be noted that the codes produced by the above-described manner can be decoded to become the original data by the decoder suitably designed in accordance with the standardization of MPEG 1, or MPEG 2.

Similar to such a case that the quantizing operation is carried out in correspondence with the quantizing scale Q, as described above, even when the quantizing operation is performed in correspondence with the quantizing scale New Q, in the case of the intra-macro block, the DCT coefficient whose value is located in the range defined from −0.5×W[i]×Q/16 to +0.5×W[i]×Q/16 is converted into the representative value data whose value is equal to 0. In a plurality of macro blocks, if the numbers of DCT coefficients to be converted into the representative value data whose value is equal to 0 are identical to each other, total output bit numbers of the variable length codes corresponding to the data of these macro blocks are not substantially changed. Therefore, this gives no adverse influence to the rate control of the variable length code by the control circuit 5.

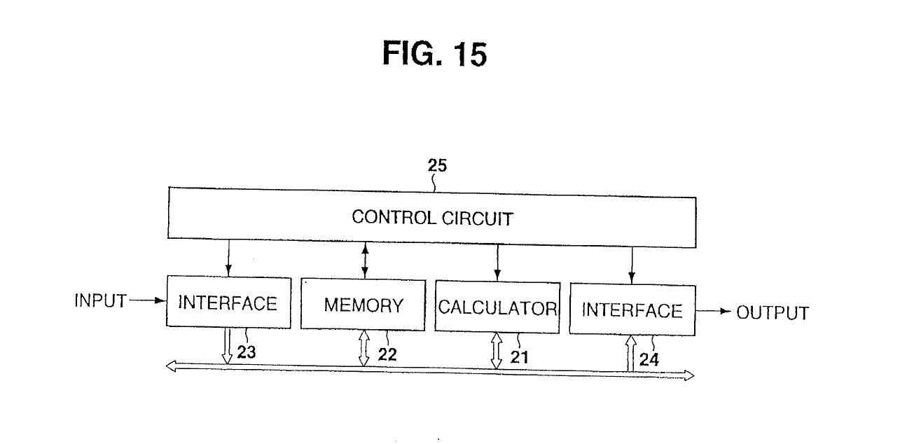

FIG. 15 schematically indicates an arrangement of a coding apparatus according to another embodiment mode of the present invention. This coding apparatus is operated in accordance with a program stored in a memory 22, and is designed to execute the process operation of the coding apparatus in a software manner.

A calculator 21 is controlled by a control circuit 25 so as to execute various sorts of calculations.

The memory 22 stores therein the program used to execute process operations similar to the process operations by the above-described coding apparatus, and also stores calculation results of the calculator 21 and further data of the calculations under execution.

Also, the memory 22 may also be used as a transmission buffer similar to the transmission buffer 4 of the coding apparatus shown in FIG. 6.

When image data is entered to an interface 23, this interface 23 outputs this image data via a bus to either the calculator 21 or the memory 22.

Another interface 24 is designed to output a produced code to a predetermined circuit (not shown).

Next, operations of this coding apparatus will now be described.

First, the interface 23 receives predetermined image data, and stores this image data into the memory 22.

Next, the calculator 21 discrete-cosine-converts this image data to thereby calculate a DCT coefficient, and processes this DCT coefficient by utilizing a quantizing scale Q supplied from the control circuit 25 to thereby calculate the above-described quantized data.

Then, the calculator 21 calculates the above-described average value “α”, or the above-explained average value “ε” from 1 micro block of quantized data, depending upon the sort of this macro block. This calculator 21 calculates a quantizing scale New Q used in the decoder side from the quantizing scale Q and either the average value “α” or the average value “ε”.

Furthermore, the calculator 21 recalculates quantized data from the DCT coefficient by utilizing this quantizing scale New Q.

Thus, the quantized data calculated by using the quantizing scale New Q in this manner is converted into the above-described representative value data. Then, Signed Level corresponding to this representative value data is variable-length-coded in combination with the quantizing scale New Q by the calculator 21.

Thus, the produced variable length code is once stored into the memory 22 functioning as the transmission buffer, and then is outputted via the interface 24 in a preselected transfer rate.

It should be noted that the control circuit 25 monitors the amount of the variable length code stored in the memory 22, and outputs a quantizing scale Q corresponding to this monitored amount to the calculator 21.

As previously described, the coding apparatus of FIG. 15 is operated in the software manner to thereby execute a process operation similar to that of the coding apparatus of FIG. 6.

As previously explained in detail, in accordance with the quantizing method and also the quantizing apparatus of the present invention, the reference value corresponding to a predetermined range is calculated from the occurrence probability distribution of the intermediate data within a preselected range, which is obtained by converting the input data by using the first quantizing scale. Also, while using the second quantizing scale calculated from the reference value and the first quantizing scale, the input data is converted into the intermediate data. Furthermore, the intermediate data in a predetermined range is converted into such a value that this value dequantized by the second quantizing scale becomes the reference value. Since such a value that this value dequantized by the second quantizing scale becomes the reference value and also the second quantizing scale are outputted, the squared mean error between the data dequantized in the decoder and the DCT coefficient of the encoder can be reduced.

Also, in accordance with the coding method and the coding apparatus of the present invention, the reference value corresponding to a predetermined range is calculated from the occurrence probability distribution of the intermediate data within a preselected range, which is obtained by converting the input data produced by the data compressing unit by using the first quantizing scale. Also, while using the second quantizing scale calculated from the reference value and the first quantizing scale, the input data is converted into the intermediate data. Furthermore, the intermediate data in a predetermined range is converted into such a value that this value dequantized by the second quantizing scale becomes the reference value. Since such a value that this value dequantized by the second quantizing scale becomes the reference value and also the second quantizing scale are decoded to be outputted, the squared mean error between the data dequantized in the decoder and the DCT coefficient of the encoder can be reduced. Also, the produced code may be decoded by the decoder suitably designed to the standardization of the MPEG system.

It should be understood that while the present invention has been described as the exemplification, as apparently from the foregoing descriptions, the present invention is not limited to those embodiments, but may be modified, changed, or substituted without departing from the technical spirit and the technical scope of the invention.

What is claimed is:

1. A quantizing apparatus for quantizing input data in correspondence with a predetermined quantizing scale, comprising:
a first calculating unit for calculating a reference value from an occurrence probability distribution of intermediate data in a predetermined range, which is obtained by converting said input data by using a first quantizing scale, said reference value corresponding to said predetermined range;
a second calculating unit for calculating a second quantizing scale from said reference value and said first quantizing scale;
a first converting unit for converting said input data into said intermediate data by utilizing said second quantizing scale;
a second converting unit for converting the intermediate data in said predetermined range into such a value that a value dequantized by said second quantizing scale becomes said reference value; and
an output unit for outputting both such a value that said value dequantized by said second quantizing scale becomes said reference value, and said second quantizing scale.

2. A quantizing apparatus as claimed in claim 1 wherein:
said reference value is equal to an average value of the intermediate data having a value within said predetermined range.

3. A quantizing apparatus as claimed in claim 1 wherein:
said intermediate data is equal to data which is directly proportional to such a value obtained by dividing said input data by a product between a weighting coefficient corresponding to said input data, and one of said first quantizing scale and said second quantizing scale.

4. A quantizing method for quantizing input data in correspondence with a predetermined quantizing scale, comprising:
a step for calculating a reference value from an occurrence probability distribution of intermediate data in a predetermined range, which is obtained by converting said input data by using a first quantizing scale, said reference value corresponding to said predetermined range;
a step for calculating a second quantizing scale from said reference value and said first quantizing scale;
a step for converting said input data into said intermediate data by utilizing said second quantizing scale;
a step for converting the intermediate data in said predetermined range into such a value that a value dequantized by said second quantizing scale becomes said reference value; and
a step for outputting both such a value that said value dequantized by said second quantizing scale becomes said reference value, and said second quantizing scale.

5. A quantizing method as claimed in claim 4 wherein:
said reference value is equal to an average value of the intermediate data having a value within said predetermined range.

6. A quantizing method as claimed in claim 4 wherein:
said intermediate data is equal to data which is directly proportional to such a value obtained by dividing said input data by a product between a weighting coefficient corresponding to said input data, and one of said first quantizing scale and said second quantizing scale.

7. A coding apparatus for coding an image signal, comprising:
a data converting unit for frequency-converting the image signal and for outputting image conversion data corresponding to said image signal;
a quantizing unit for quantizing said image conversion data by a predetermined quantizing scale;
a coding unit for coding the quantized image conversion data; and
a calculating unit for calculating said quantizing scale in correspondence with an amount of a code outputted from said coding unit; wherein said quantizing unit is further comprised of:
a first calculating unit for calculating a reference value from an occurrence probability distribution of intermediate data in a predetermined range, which is obtained by converting said input data by using a first quantizing scale, said reference value corresponding to said predetermined range;
a second calculating unit for calculating a second quantizing scale from said reference value and said first quantizing scale;
a first converting unit for converting said input data into said intermediate data by utilizing said second quantizing scale;
a second converting unit for converting the intermediate data in said predetermined range into such a value that a value dequantized by said second quantizing scale becomes said reference value; and
an output unit for outputting both such a value that said value dequantized by said second quantizing scale becomes said reference value, and said second quantizing scale.

8. A coding apparatus as claimed in claim 7 wherein:
said reference value is equal to an average value of the intermediate data having a value within said predetermined range.

9. A coding apparatus as claimed in claim 7 wherein:
said intermediate data is equal to data which is directly proportional to such a value obtained by dividing said input data by a product between a weighting coefficient corresponding to said input data, and one of said first quantizing scale and said second quantizing scale.

10. A coding method for coding an image signal, comprising:
a step for frequency-converting the image signal and for outputting image conversion data corresponding to said image signal;
a step for quantizing said image conversion data by a predetermined quantizing scale;
a step for coding the quantized image conversion data; and
a step for calculating said quantizing scale in correspondence with an amount of a code outputted from said coding unit; wherein said quantizing step is further comprised of:
a step for calculating a reference value from an occurrence probability distribution of intermediate data in a predetermined range, which is obtained by converting said input data by using a first quantizing scale, said reference value corresponding to said predetermined range;
a step for calculating a second quantizing scale from said reference value and said first quantizing scale;
a step for converting said input data into said intermediate data by utilizing said second quantizing scale;
a step for converting the intermediate data in said predetermined range into such a value that a value dequantized by said second quantizing scale becomes said reference value; and
a step for outputting both such a value that said value dequantized by said second quantizing scale becomes said reference value, and said second quantizing scale.

11. A coding method as claimed in claim 10 wherein:
said reference value is equal to an average value of the intermediate data having a value within said predetermined range.

12. A coding method as claimed in claim 10 wherein:
said intermediate data is equal to data which is directly proportional to such a value obtained by dividing said input data by a product between a weighting coefficient corresponding to said input data, and one of said first quantizing scale and said second quantizing scale.

13. In a machine-readable-program storage medium for storing a program instruction executable by the machine so as to execute a process step for quantizing image data, said process step comprising:
a step for calculating a reference value from an occurrence probability distribution of intermediate data in a predetermined range, which is obtained by converting said input data by using a first quantizing scale, said reference value corresponding to said predetermined range;
a step for calculating a second quantizing scale from said reference value and said first quantizing scale;
a step for converting said input data into said intermediate data by utilizing said second quantizing scale;
a step for converting the intermediate data in said predetermined range into such a value that a value dequantized by said second quantizing scale becomes said reference value; and
a step for outputting both such a value that said value dequantized by said second quantizing scale becomes said reference value, and said second quantizing scale.

14. A machine-readable-program storage medium as claimed in claim 13 wherein:
said reference value is equal to an average value of the intermediate data having a value within said predetermined range.

15. A machine-readable-program storage medium as claimed in claim 13 wherein:
said intermediate data is equal to data which is directly proportional to such a value obtained by dividing said input data by a product between a weighting coefficient corresponding to said input data, and one of said first quantizing scale and said second quantizing scale.

16. In a machine-readable-program storage medium for storing a program instruction executable by the machine so as to execute a process step for quantizing image data, said process step comprising:
a step for frequency-converting the image signal and for outputting image conversion data corresponding to said image signal;
a step for quantizing said image conversion data by a predetermined quantizing scale;
a step for coding the quantized image conversion data; and
a step for calculating said quantizing scale in correspondence with an amount of a code outputted from said coding unit; wherein said quantizing step is further comprised of:
a step for calculating a reference value from an occurrence probability distribution of intermediate data in a predetermined range, which is obtained by converting said input data by using a first quantizing scale, said reference value corresponding to said predetermined range;
a step for calculating a second quantizing scale from said reference value and said first quantizing scale;
a step for converting said input data into said intermediate data by utilizing said second quantizing scale;
a step for converting the intermediate data in said predetermined range into such a value that a value dequantized by said second quantizing scale becomes said reference value; and
a step for outputting both such a value that said value dequantized by said second quantizing scale becomes said reference value, and said second quantizing scale.

17. A machine-readable-program storage medium as claimed in claim 16 wherein:
said reference value is equal to an average value of the intermediate data having a value within said predetermined range.

18. A machine-readable-program storage medium as claimed in claim 16 wherein:
said intermediate data is equal to data which is directly proportional to such a value obtained by dividing said input data by a product between a weighting coefficient corresponding to said input data, and one of said first quantizing scale and said second quantizing scale.
